(19) United States
(12) Patent Application Publication
(10) Pub. No.: US 2024/0418286 A1
(43) Pub. Date: Dec. 19, 2024

(54) PIEZOELECTRIC VALVE

(71) Applicants: SATAKE CORPORATION, Chiyoda-ku, Tokyo (JP); MECHANO TRANSFORMER CORPORATION, Chiyoda-ku, Tokyo (JP)

(72) Inventors: Takafumi ITO, Chiyoda-ku, Tokyo (JP); Tadashi MATSUSHITA, Chiyoda-ku, Tokyo (JP); Sze Keat CHEE, Chiyoda-ku, Tokyo (JP); Zhengli WANG, Chiyoda-ku, Tokyo (JP)

(73) Assignees: SATAKE CORPORATION, Chiyoda-ku, Tokyo (JP); MECHANO TRANSFORMER CORPORATION, Chiyoda-ku, Tokyo (JP)

(21) Appl. No.: 18/701,637

(22) PCT Filed: Oct. 21, 2022
(86) PCT No.: PCT/JP2022/039415

§ 371 Date: Apr. 16, 2024

(30) Foreign Application Priority Data
Oct. 29, 2021 (JP) 2021-177621

(51) Int. Cl. F16K 31/00; F16K 11/22; F16K 11/24; F16K 27/04

(52) U.S. Cl. CPC F16K 31/004; F16K 11/22; F16K 11/24; F16K 27/044

(57) ABSTRACT

A piezoelectric valve includes: actuators having valve discs and configured to drive these valve discs individually; a valve seat plate having valve seats contacted with and separated from the valve discs individually and discharge paths; and a body case accommodating the valve seat plate, and each actuator is fixed to the side face of the valve seat plate so that the valve discs face the valve seats and can be attached to and detached from a fluidic device via a connector part provided to the front face of the body case. The valve seats are provided as a pair to both faces of the valve seat part, the discharge paths opened in the valve seats provided as a pair are formed in the valve seat plate, gas discharge ports are opened in a non-straight manner, and discharge ports of discharge passages are opened in a line.

### TECHNICAL FIELD

The present invention relates to a piezoelectric valve configured to open and close a valve by using displacement of a piezoelectric element.

### BACKGROUND ART

Piezoelectric valves configured to open and close a valve by using displacement of a piezoelectric element to eject a compressed gas are conventionally well known (see Patent Literatures 1 to 3 listed below).

The piezoelectric valves disclosed in Patent Literatures 1 to 3 have an actuator that takes advantage of characteristics of a piezoelectric element superior in fast response performance. The disclosed piezoelectric valves further have a displacement amplifying mechanism for amplifying small displacement of a piezoelectric element based on the principle of leverage in the actuator.

The following finding has been obtained experimentally and empirically. Since the disclosed piezoelectric valves have excellent responsiveness, when a piezoelectric valve is used for an ejector valve in an optical sorting machine targeted to granular materials such as rice grains to remove defective products, non-defective products are less likely to be removed together with the defective products, and the rate of inclusion of defective products in a group of products removed as defective one is higher in piezoelectric valves than in magnetic valves.

When a piezoelectric valve is used as an ejector valve or the like in an optical sorting machine, the piezoelectric valve is directly and continuously attached to a manifold having a space therein to which compressed air is supplied from a compressed air source, and a large number of nozzle holes are opened in the tip of the ejector, as disclosed in Patent Literature 3 below, for example.

The inventors of the present invention described later have first proposed a piezoelectric valve including a displacement amplifying mechanism having an actuator with simple structure (see Patent Literature 4 listed below).

The piezoelectric valve disclosed in Patent Literature 4 has a valve seat plate, the valve seat plate has a valve seat part in which a valve seat and a discharge path are formed, and the valve seat is provided to both faces on the front face side and the back face side of the valve seat part. A plurality of actuators are fixed on both sides interposing the valve seat part of the valve seat plate so that each valve disc faces each valve seat.

In the piezoelectric valve disclosed in Patent Literature 4, the valve seat plate to which the actuators are fixed is accommodated within a case of the valve body. It is thus possible to reduce the dimension in the width direction in front view compared to the piezoelectric valves disclosed in Patent Literatures 1 to 3. Thus, in the piezoelectric valve disclosed in Patent Literature 4, it is possible to reduce the pitch in the width direction of the air discharge port opened in the front face of the valve body.

In the piezoelectric valve disclosed in Patent Literature 4, however, when the discharge paths opened in the valve seats on both faces of the valve seat part in the valve seat plate are formed so as to overlap each other in the width direction, these discharge paths are not opened in a line in the width direction in the front face of the valve seat plate. Thus, there is a problem of difficulty in the air discharge ports being aligned and opened in a line in the width direction in the front face of the valve body.

### CITATION LIST

### Patent Literature

Patent Literature 1: International Publication No. 2013/088661
Patent Literature 2: Japanese Patent Application Laid-Open No. 2021-8892
Patent Literature 3: Japanese Patent Application Laid-Open No. 2015-137664
Patent Literature 4: Japanese Patent Application Laid-Open No. 2022-48474

### Summary of Invention

### Problem to be Solved by the Invention

Accordingly, an object of the present invention is to provide a piezoelectric valve in which gas discharge ports can be aligned and opened in a line in the width direction in the front face of the valve.

### Solution to Problem

To achieve the object described above, the piezoelectric valve according to the present invention includes:
a plurality of actuators having a plurality of valve discs and configured to drive the plurality of valve discs in parallel planes, respectively, individually;
a valve seat plate having a plurality of valve seats and a plurality of discharge paths and configured to fix the plurality of actuators, the valve seats being contacted with and separated from the plurality of valve discs, respectively, individually; and
a body case configured to accommodate the valve seat plate,
each of the plurality of actuators includes:
a base part fixed to the valve seat plate,
a piezoelectric element extending in a first longitudinal direction, one end of the piezoelectric element being connected to a mounting surface of the base part,
a support part provided integrally with the base part, adjacent to arranged the piezoelectric element, and extending in a second longitudinal direction intersecting the first longitudinal direction, and
an acting part connected to the other end of the piezoelectric element and a tip of the support part and configured to be displaced in a direction which is different from both the first longitudinal direction and the second longitudinal direction in accordance with expansion and contraction of the piezoelectric element,
the valve disc is provided on a side of the direction that displacement of the acting part occurs and driven by the displacement of the acting part,
the valve seat plate has a valve seat part in which the valve seats and the discharge paths are formed, and the plurality of valve seats are provided to both faces on a front face side and a rear face side of the valve seat part,
the plurality of actuators are fixed to side faces of the valve seat plate so that each of the valve discs faces each of the valve seats,
the body case includes:
a gas supply port supplied with a compressed gas, and
a plurality of gas discharge ports configured to, by separation of the plurality of valve discs and the plurality of valve seats from each other, discharge a compressed gas, supplied from the gas supply port, via the plurality of discharge paths of the valve seat plate, respectively, individually,
the body case is configured to be attached to and detached from a fluidic device via a connector part provided to a front face of the body case,
the connector part has an intake passage and a plurality of discharge passages, one end of the intake passage is configured to communicate with the gas supply port opened in the front face of the body case while the other end of the intake passage is configured to communicate with a feed passage formed in the fluidic device, and one ends of the plurality of discharge passages are configured to respectively communicate with the plurality of gas discharge ports opened in the front face of the body case, while the other ends of the plurality of discharge passages are configured to respectively communicate with a plurality of exhaust passages formed in the fluidic device,
the valve seats of the valve seat plate are provided as a pair to both the faces of the valve seat part so as to overlap each other at least partially in a width direction in front view,
the discharge paths having one ends opened in the valve seats provided as a pair to both the faces of the valve seat part are formed in the valve seat plate so as to overlap each other at least partially in the width direction,
in the valve seat plate, the other ends of the plurality of discharge paths are opened in a non-straight manner in the width direction,
in the front face of the body case, the plurality of gas discharge ports are opened in a non-straight manner in the width direction, and
in a front face of the connector part, discharge ports of the plurality of discharge passages are opened in a line in the width direction.

Herein, “width direction” in the present invention means the width direction in front view of the piezoelectric valve unless otherwise specified.

In a preferred aspect of the piezoelectric valve according to the present invention,
the plurality of discharge passages of the connector part respectively have spaces of the same volume, and have openings of the same opening area in the front face of the connector part.

In a preferred aspect of the piezoelectric valve according to the present invention,
the plurality of gas discharge ports of the body case have openings of the same opening area in the front face of the body case.

In a preferred aspect of the piezoelectric valve according to the present invention,
the plurality of discharge passages of the connector part each have an opening of a slot shape in the rear face of the connector part, and the slot shape is obtained by projecting each opening of the plurality of gas discharge ports opened in the front face of the body case and each opening of discharge ports of the plurality of discharge passages opened in the front face of the connector part onto the rear face of the connector part and then connecting both the openings to each other.

In a preferred aspect of the piezoelectric valve according to the present invention,
the fluidic device is a manifold, feeds a supplied compressed gas, supplied from a compressed gas source, into the body case from the feed passage via the intake passage of the connector part, and exhausts a discharged compressed gas, discharged out of the body case, from the plurality of exhaust passages via the plurality of discharge passages of the connector part.

### Advantageous Effects of Invention

According to the piezoelectric valve of the present invention, even when a plurality of gas discharge ports are not opened in a line in the width direction in the front face of the body case, the gas discharge ports can be aligned and opened in a line in the width direction in the front face of the valve.

According to the preferred aspect of the piezoelectric valve of the present invention, various characteristics such as a gas ejection amount or ejection speed from the front face of the valve, or responsiveness can be designed to have substantially the same among a plurality of discharge passages to obtain a good state comparable to a case where no connector part is provided.

According to the preferred aspect of the piezoelectric valve of the present invention, when the piezoelectric valve is attached to a manifold, such a piezoelectric valve can be used for an ejector in an optical sorting machine, for example.

### BRIEF DESCRIPTION OF DRAWINGS

FIG. 1 is a perspective view of a piezoelectric valve according to an embodiment of the present invention.

FIG. 2 is a front view of the piezoelectric valve shown in FIG. 1.

FIG. 3 is a plan view of the piezoelectric valve shown in FIG. 1.

FIG. 4 is a perspective view of an embodiment of a valve body of the piezoelectric valve according to the present invention.

FIG. 5 is a perspective view of an embodiment of an actuator in the piezoelectric valve according to the present invention.

FIG. 6 is a perspective view of an embodiment of a valve seat plate in the piezoelectric valve according to the present invention.

FIG. 7 is a front view of the valve seat plate shown in FIG. 6.

FIG. 8 is a side view of the valve seat plate shown in FIG. 6.

FIG. 9 is a perspective view of the valve seat plate illustrated in FIGS. 6 to 8 in a state where actuators in FIG. 5 are fixed.

FIG. 10 is a front view of the valve seat plate in the state shown in FIG. 9.

FIG. 11 is a side view of the valve seat plate in the state in FIG. 9.

FIG. 12 is a bottom view of the valve seat plate in the state in FIG. 9.

FIG. 13 is an illustration diagram of an ejector to which an embodiment of the piezoelectric valve according to the present invention is attached when viewed from the side of the front face.

FIG. 14 is a sectional view illustrating the ejector when viewed from a cross section F-F shown in FIG. 13.

FIG. 15 is a left side view of an embodiment of a connector part in the piezoelectric valve according to the present invention.

FIG. 16 is a plan view of the connector part shown in FIG. 15.

FIG. 17 is a bottom view of the connector part shown in FIG. 15.

FIG. 18 is an assembly exploded view of the piezoelectric valve illustrated in FIG. 1.

### MODES FOR CARRYING OUT THE INVENTION

Embodiments of the present invention will be described with reference to the drawings.

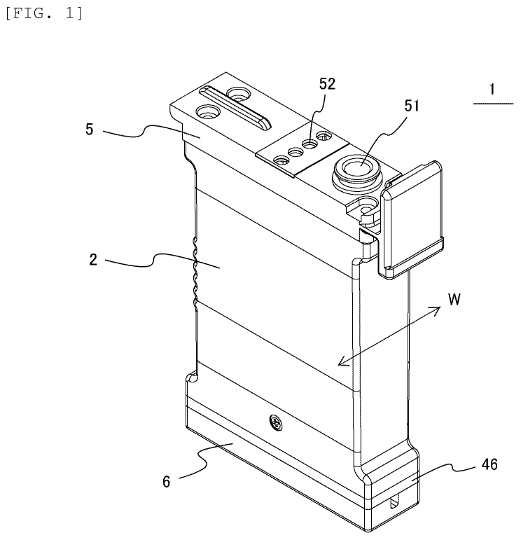

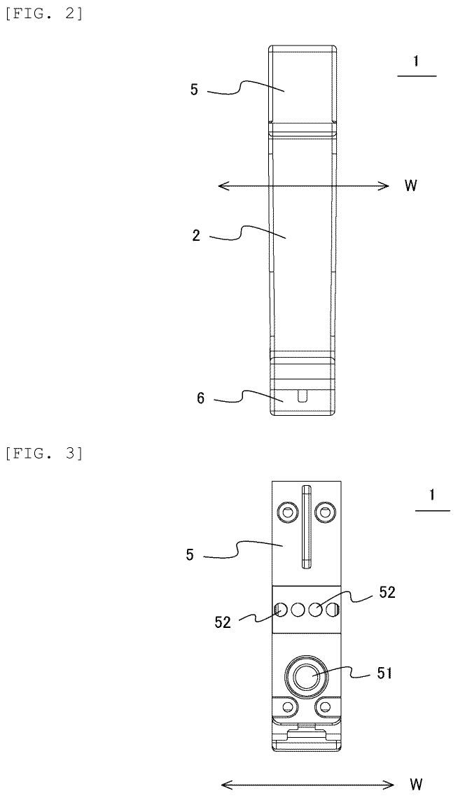

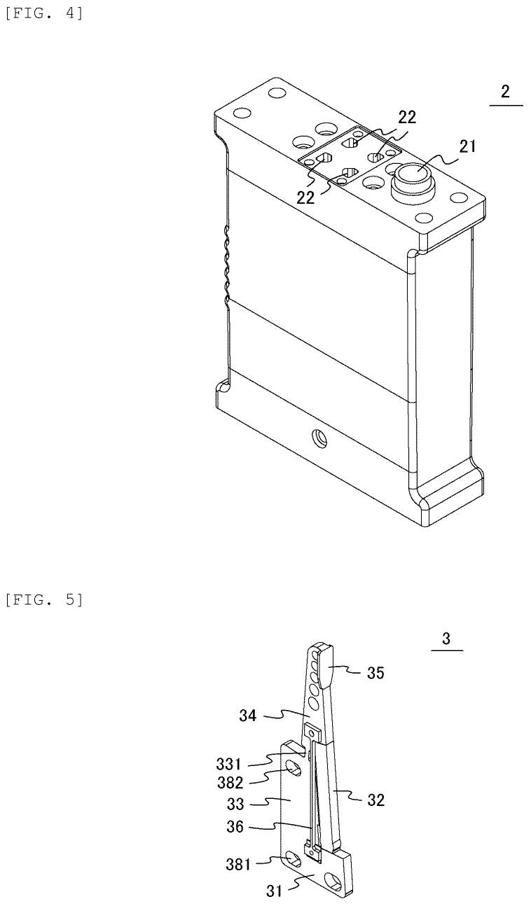

FIG. 1 illustrates a perspective view of a piezoelectric valve according to an embodiment of the present invention. FIG. 2 illustrates a front view of the piezoelectric valve shown in FIG. 1. FIG. 3 illustrates a plan view of the piezoelectric valve in FIG. 1. FIG. 4 illustrates a perspective view of a valve body.

In the embodiment of the present invention, a piezoelectric valve 1 has a valve body 2, actuators 3 described later, and a valve seat plate 4 described later arranged inside the valve body 2 with the actuators 3 being fixed thereto.

The valve body 2 is a case whose rear face (corresponding to the bottom face in FIG. 4) is opened. The valve body 2 has a gas pressure chamber therein that is supplied with a compressed gas from an external compressed gas source (not illustrated).

Further, as illustrated in FIG. 1, the front face of the valve body 2 (corresponding to the top face in FIG. 4) is provided with a connector part 5 to which a manifold (not illustrated) having a space therein that is supplied with a compressed gas from the compressed gas source can be attached.

In the front face (corresponding to the top face of FIG. 1) of the connector part 5, an intake port 51 to take a compressed gas into the valve body 2 and a plurality of discharge ports 52 to discharge the compressed gas are opened.

Further, a gas supply port 21 communicating with the intake port 51 of the connector part 5 and a plurality of gas discharge ports 22 communicating with the respective discharge ports 52 of the connector part 5 are opened in the front face of the valve body 2.

As illustrated in FIG. 1 and FIG. 2, a cover 6 is attached to the rear face of the valve body 2. A cable (not illustrated) provided for powering a piezoelectric element 32 described later is drawn out of the opening formed in the front face side of the cover 6.

Note that the term “width direction” in the embodiment of the present invention means a width direction W in front view of the piezoelectric valve as illustrated in FIGS. 1 to 3, for example, unless otherwise specified.

FIG. 5 illustrates a perspective view of one embodiment of an actuator.

The actuator 3 has a base part 31 fixed to the valve seat plate 4 described later and the piezoelectric element 32 whose one end is connected to the mounting surface of the base part 31 and which extends in the first longitudinal direction. The actuator 3 further has a support part 33 formed integrally with the base part 31 and arranged so as to be aligned along the piezoelectric element 32. The support part 33 extends in the second longitudinal direction intersecting with the first longitudinal direction.

The actuator 3 has an acting part 34 connected to the other end of the piezoelectric element 32 and to the tip of the support part 33. The acting part 34 is displaced in a different direction from both the first longitudinal direction and the second longitudinal direction in accordance with expansion and contraction of the piezoelectric element 32. The actuator 3 further has a valve disc 35 provided on the tip side of the acting part 34 and on one side face in the displacing direction. The valve disc 35 is driven by the displacement of the acting part 34.

The base part 31 has at least one mounting hole(s) 381, and at least one of the mounting holes 381 is arranged on the side on which the support part 33 is integrally provided in the second longitudinal direction. The base part 31 is fixed to the valve seat plate 4 by screws with the use of the mounting hole(s) 381 arranged at least on the side on which the support part 33 is integrally provided.

Further, the support part 33 has a narrow part 331 in the intermediate portion extending in the second longitudinal direction. The support part 33 further has a mounting hole 382 on the base part 31 side with respect to the narrow part 331. The support part 33 is fixed to the valve seat plate 4 by a screw with the use of the mounting hole 382.

The support part 33 and the acting part 34 of the actuator 3 can be understood as elements forming a displacement amplifying mechanism for amplifying a displacement of the piezoelectric element 32 to exert the amplified displacement on the valve disc 35. That is, in accordance with expansion and contraction of the piezoelectric element 32, the acting part 34 is displaced in a different displacement direction from both the first longitudinal direction and the second longitudinal direction in a plane substantially parallel to a plane including the first longitudinal direction and the second longitudinal direction.

In this displacement, because the narrow part 331 is provided in the intermediate portion extending in the second longitudinal direction of the support part 33, the actuator 3 can amplify the displacement of the acting part 34 caused by the expansion and contraction of the piezoelectric element 32.

Herein, the base part 31 and the support part 33 can be molded into an integrated member by punching a metal material. A preferred metal material as the material of the integrated member of the base part 31 and the support part 33 is a stainless material including an invar material, for example. Punching a metal material to integrally mold the base part 31 and the support part 33 reduces the number of components and facilitates assembly of the actuator 3.

Further, the base part 31 and the support part 33 may be formed from separate members. In such a case, it is possible to integrally provide the support part 33 and the base part 31 by mounting the support part 33, which is a separate member from the base part 31, on the base part 31.

A coupling member (not illustrated) made of an aluminum block or the like can be mounted on the mounting surface of the base part 31 on which the piezoelectric element 32 is mounted. In such a way, it is preferable that the material forming the coupling member be made of a material having a larger coefficient of linear expansion than that forming the support part 33. Mounting the piezoelectric element 32 on the base part 31 via the coupling member formed of a material having a larger coefficient of linear expansion than that forming the support part 33 can reduce or eliminate the influence of thermal expansion or contraction of the piezoelectric element 32 due to a change in temperature. The coupling member can be mounted not only on the mounting surface of the base part 31 but also between the piezoelectric element 32 and the acting part 34.

The acting part 34 can be formed of a light-weight material such as an aluminum material. Forming the acting part 34 with a light-weight material is preferable in terms of displacement of the acting part 34. Further, the valve disc 35 can be made of a rubber, preferably, formed of an elastomeric rubber.

In the actuator 3, the base part 31 and the acting part 34 can be coupled to each other via a compression member 36.

In general, piezoelectric elements are likely to be damaged by a load in the tensile direction. However, when the base part 31 and the acting part 34 are coupled to each other via the compression member 36, damage on the piezoelectric element 32 can be prevented on the ground that the piezoelectric element 32 can be compressed in the first longitudinal direction.

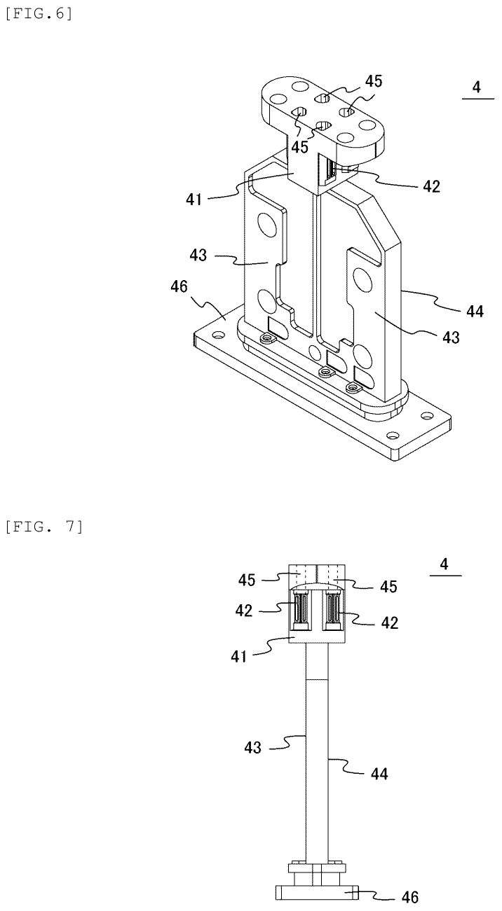

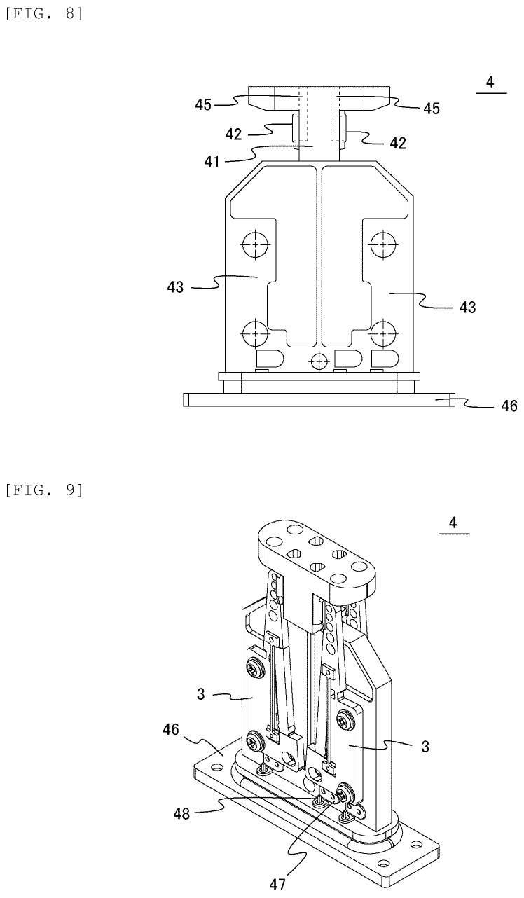

FIG. 6 illustrates a perspective view of one embodiment of the valve seat plate. FIG. 7 illustrates a front view of the valve seat plate in FIG. 6. FIG. 8 illustrates a side view of the valve seat plate in FIG. 6.

The valve seat plate 4 illustrated in FIG. 6 exemplifies a valve seat plate on which four actuators can be mounted. The valve seat plate 4 has a valve seat part 41 in the center portion. Both opposing faces of the valve seat part 41 that correspond to the front face side and the back face side are provided with two valve seats 42 with which valve discs 35 in actuators 3 come into contact.

Herein, the valve seats 42 are provided so as to partially overlap each other in the width direction in the front view and oppose to each other as a pair on both faces of the valve seat part 41.

Mounting parts 43, 43 of the actuators 3 are formed on one side face of the valve seat plate 4. More specifically, the mounting parts 43, 43 are respectively formed on both faces of the valve seat part 41 on one side face of the valve seat plate 4, that is, in opposing positions on the front face side and the back face side of the valve seat part 41. Also on the other side face of the valve seat plate 4, mounting parts 44 of the actuators 3 are respectively also formed in opposing positions in both faces of the valve seat part 41.

As illustrated in FIG. 8, a plurality of discharge paths 45 are formed in the valve seat part 41. One end of each discharge path 45 is opened in the valve seat face of each valve seat 42. Note that the other end of each discharge path 45 is opened in the front face of the valve seat plate 4 (corresponding to the top face in FIGS. 6 to 8). Further, in the valve seat plate 4, a lid 46 to close the opening in the rear face of the valve body 2 is provided integrally with the valve seat plate 4.

Herein, the discharge paths 45 one ends of which are opened in respective valve seats 42 provided to both faces of the valve seat part 41 as a pair opposing to each other are formed in the valve seat plate 4 so as to overlap each other in the width direction. Thus, as illustrated in FIG. 6, the other ends of the plurality of discharge paths 45 are opened in a non-straight manner in the width direction (not opened in a line in the width direction) in the front face of the valve seat plate 4. Furthermore, as illustrated in FIG. 4, the plurality of gas discharge ports 22 are opened in a non-straight manner in the width direction in the front face of the valve body 2 in which the valve seat plate 4 is accommodated.

Note that the valve seats 42 of the valve seat plate 4 are provided as a pair on both faces of the valve seat part 41 so as to overlap each other at least partially in the width direction in front view. The discharge paths 45 one ends of which are opened in respective valve seats 42 provided as a pair on both faces of the valve seat part 41 can be formed in any way as long as they are formed in the valve seat plate 4 so as to overlap each other at least partially in the width direction.

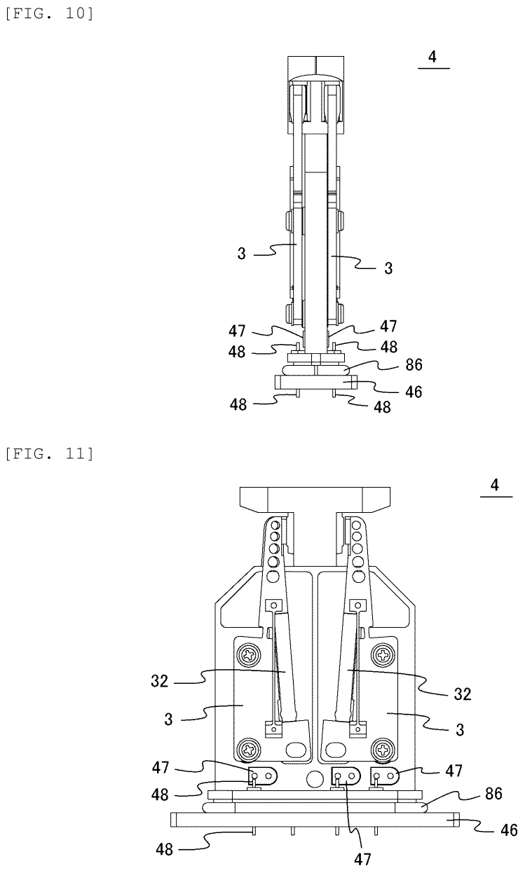

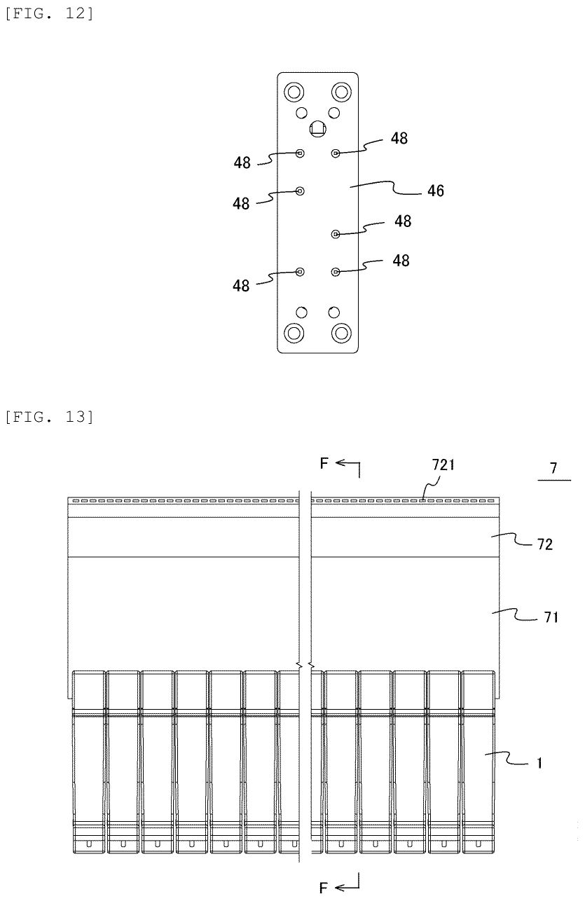

FIG. 9 illustrates a perspective view of the valve seat plate 4 in a state where the actuator 3 is fixed. FIG. 10 illustrates a front view of the valve seat plate 4 of FIG. 9. FIG. 11 illustrates a side view of the valve seat plate 4 of FIG. 9. FIG. 12 illustrates a bottom view of the valve seat plate 4 of FIG. 9.

In the present embodiment, for each of the mounting parts 43, 44 of the valve seat plate 4, each valve disc 35 of four actuators 3 is arranged so as to face each valve seat 42. In the present embodiment, each actuator 3 is fixed to the valve seat plate 4 by a screw.

Electrodes 47 provided for connection to lead wires (not illustrated) of the piezoelectric elements 32 in the actuators 3 are provided at rear positions (downward in FIGS. 9 to 11) of the valve seat plate 4. Further, wiring pins 48 provided for powering the piezoelectric elements 32 are molded at rear positions of the valve seat plate 4.

At the rear end of the valve seat plate 4, the lid 46 to close the opening in the case rear face of the valve body 2 is provided integrally with the valve seat plate 4. While one end of each wiring pin 48 is connected to the electrode 47, the other end thereof extends rearward out of the rear face (the bottom face in FIGS. 9 to 11) of the lid 46 and is connected to a cable (not illustrated) provided for powering the piezoelectric element 32.

Herein, the electrode 47 is connected to the lead wire of the piezoelectric element 32 and the wiring pin 48 and, in this state, can be coated with an insulating material together with one end side of the wiring pin 48. An example of a preferred insulating material used in such coating may be an insulating resin material such as silicone.

With such coating, in addition to the effect of the molding of the wiring pin 48 in the valve seat plate 4, short circuit due to a water droplet or the like can be prevented.

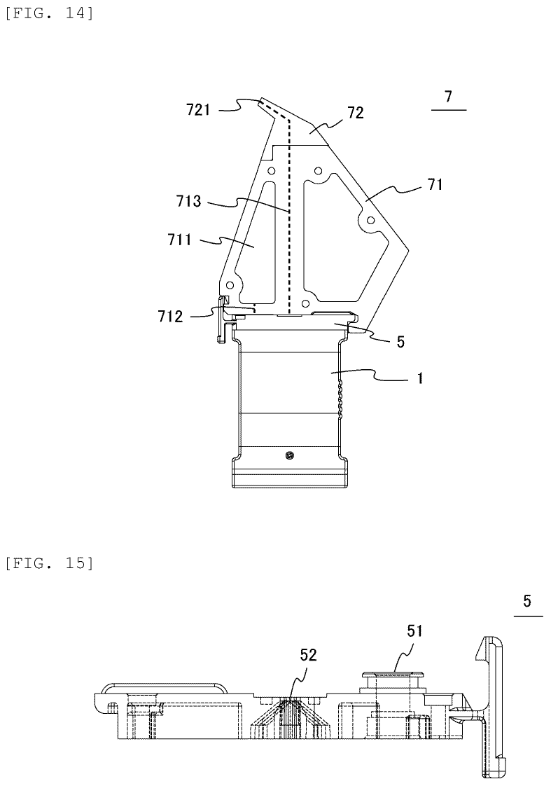

FIGS. 13 and 14 are illustration diagrams of an ejector in an optical sorting machine. Specifically, FIG. 13 depicts an illustration diagram of an embodiment of the ejector as viewed from the front face side, and FIG. 14 is the sectional view of FIG. 13 and depicts an illustration diagram of the ejector as viewed from the side face side.

An ejector 7 illustrated in FIGS. 13 and 14 includes a manifold 71 having an air space 711 therein to which compressed air is supplied from a compressed air source (not illustrated). The ejector 7 further includes the piezoelectric valve 1, attached to the manifold 71 via the connector part 5, and includes a nozzle member 72 mounted on the manifold 71.

The manifold 71 has a number of feed passages 712 and a number of exhaust passages 713 communicating with the air space 711 in the longitudinal direction. The feed passages 712 and the exhaust passages 713 are opened on respective straight lines in the longitudinal direction. The nozzle hole 721 of the nozzle member 72 is provided so as to communicate with each of a number of exhaust passages 713.

The piezoelectric valve 1 is attached to the manifold 71. The intake port 51 of the connector part 5 communicates with the feed passage 712 in the manifold 71. The plurality of discharge ports 52 of the connector part 5 communicate with the plurality of exhaust passages 713 in the manifold 71.

One feed passage 712 and four exhaust passages 713 are paired, such pairs of the feed passage 712 and the exhaust passages 713 being formed in the manifold 71 in the longitudinal direction. The number of pairs corresponds to the number of piezoelectric valves 1 attached to the manifold 71.

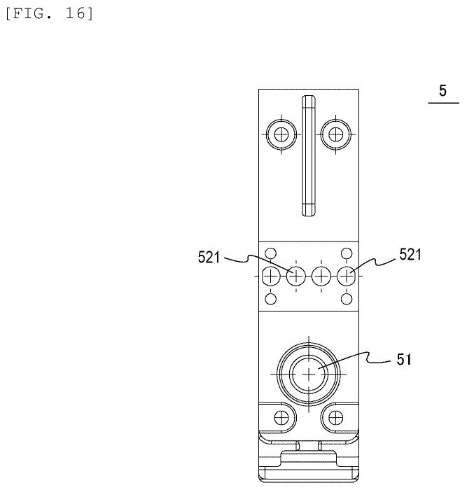

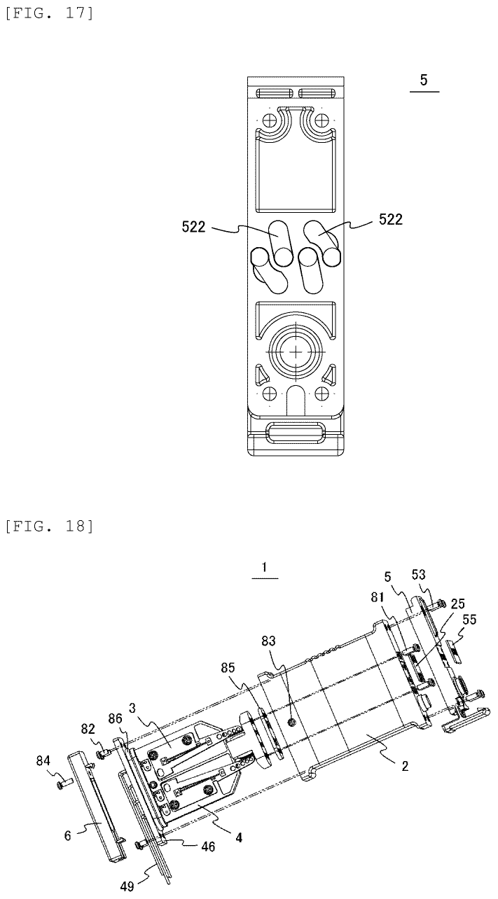

FIG. 15 illustrates a left side view of an embodiment of the connector part. FIG. 16 illustrates a plan view of the connector part shown in FIG. 15. FIG. 17 illustrates a bottom view of the connector part shown in FIG. 15.

In the connector part 5, an intake passage is formed. The intake passage allows one end thereof to communicate with the gas supply port 21 opened in the front face of the valve body 2 in the rear face of the connector part 5 and the other end thereof to communicate with the feed passage 712 formed in the manifold 71 in the front face of the connector part 5.

Furthermore, in the connector part 5, a plurality of discharge passages are formed. Each discharge passage allows one end thereof to communicate with the plurality of gas discharge ports 22 opened in the front face of the valve body 2 in the rear face of the connector part 5 and the other end thereof to communicate with the plurality of exhaust passages 713 opened in the bottom face of the manifold 71 in the front face of the connector part 5.

The discharge ports 52 for the plurality of discharge passages (illustrated as the other end side openings 521 in FIG. 16) are opened in a line in the width direction in the front face of the connector part 5. The discharge passages communicate with respective exhaust passages 713 opened on a straight line in the longitudinal direction in the bottom face of the manifold 71.

Further, the plurality of discharge passages are each opened in a slot shape in the rear face of the connector part 5 (see one end side opening 522 illustrated in FIG. 17). In the present embodiment, the opening of each discharge passage provided in the rear face of the connector part 5 corresponds to a shape obtained by projecting each opening of the plurality of gas discharge ports 22 opened in the front face of the valve body 2 and each opening of the plurality of discharge ports 52 opened in the front face of the connector part 5 onto the rear face of the connector part 5 and then connecting both the openings to each other. These discharge passages communicate with the plurality of gas discharge ports 22 opened in a non-straight manner in the width direction in the front face of the valve body 2.

The plurality of discharge passages formed in the connector part 5 have respective spaces of substantially the same spatial volume and respective openings (discharge ports 52) of substantially the same opening area in the front face of the connector part 5.

Further, the plurality of gas discharge ports 22 opened in the front face of the valve body 2 have substantially the same opening area.

FIG. 18 illustrates an assembly exploded view of the piezoelectric valve illustrated in FIG. 1.

In assembly of the piezoelectric valve 1, the valve seat plate 4 having the four actuators 3 fixed thereto is inserted into the case from the opening in the rear face of the valve body 2, and the opening of the rear face of the valve body 2 is closed by the lid 46 provided to the valve seat plate 4. Subsequently, the cover 6 is fixed to the rear face of the lid 46, and the connector part 5 is mounted on the front face of the valve body 2. Accordingly, the piezoelectric valve 1 can be assembled.

In the front part that is the side having the discharge paths 45, the front face of the valve seat plate 4 in which the discharge paths 45 are opened is fixed to the valve body 2 from front by screws 81, 81 inside the case of the valve body 2. Accordingly, each discharge path 45 of the valve seat plate 4 communicates with each gas discharge port 22 opened in the front face of the valve body 2.

Further, in the rear part that is the side to fix the actuators 3, the lid 46 of the valve seat plate 4 is fixed to the valve body 2 from rear by screws 82, 82 and closes the opening in the rear face of the valve body 2.

In this process, it is possible to prevent gas leakage from the valve body 2 by using a packing 85 to seal a portion where the front face of the valve seat plate 4 is fixed to the front side inner face of the valve body 2 and where the discharge paths 45 of the valve seat plate 4 and the gas discharge ports 22 of the valve body 2 communicate with each other. Furthermore, it is also possible to prevent gas leakage from the valve body 2 by using an O-ring 86 to seal a portion where the lid 46 of the valve seat plate 4 closes the opening in the rear face of the valve body 2.

Further, the cover 6 used for drawing a cable 49 out of the opening on the front face side is fixed to the rear face of the lid 46 of the valve seat plate 4 by a screw 84 or the like. Herein, the cable 49 is connected to the wiring pin 48 extending rearward out of the rear face of the lid 46 and provided for powering the piezoelectric element 32.

The connector part 5 is fixed to the front face of the valve body 2 from front by screws 53, 53. In this process, a portion where the gas discharge ports 22 opened in the front face of the valve body 2 communicate with openings of the plurality of discharge passages (one end side openings 522) opened in the rear face of the connector part 5 is sealed by a packing 25.

Furthermore, a packing 55 is provided to a portion in the front face of the connector part 5 where the plurality of discharge ports 52 (the other end side openings 521) are opened. The packing 55 provided to the front face of the connector part 5 seals a portion where the discharge ports 52 of the connector part 5 communicate with the exhaust passages of the manifold 71 when the piezoelectric valve 1 is attached to the manifold 71.

In the piezoelectric valve 1, the valve seat plate 4 is fixed to the valve body 2 in the front part, which is the side having the discharge paths 45, and the rear part, which is the side to fix the actuators 3, and therefore, the valve seat plate 4 does not swing and come into contact with the inner face of the valve body 2. Therefore, according to the embodiment of the piezoelectric valve of the present invention, it is possible to prevent breakage due to an impact, which would otherwise be caused when the valve seat plate 4 comes into contact with the inner face of the valve body 2, or malfunction due to such contact.

Further, in the piezoelectric valve 1, the front face of the valve seat plate 4 in which the discharge paths 45 are opened is fixed to the valve body 2 from front by screws 81, 81 inside the case of the valve body 2 in the front part, which is the side having the discharge paths 45. Further, in the piezoelectric valve 1, the lid 46 is fixed to the valve body 2 from rear by screws 82, 82 in the rear part, which is the side to fix the actuators 3. Thus, the piezoelectric valve 1 can be disassembled by removal of the screws, and this enables investigation of the cause of a failure or repairment in a case of the failure.

Furthermore, in the valve seat plate 4, as illustrated in FIG. 18, both side faces of the valve seat plate 4 can be fixed to the valve body 2 by screws 83, 83 in the rear part that is the side to fix the actuators 3. In such a way, because the valve seat plate 4 is fixed to the valve body 2 from both lateral sides of the valve seat plate 4 by using screws 83, 83 in the rear part that is the side to fix the actuators 3, expansion in the width direction of the case of the valve body 2 is suppressed smaller, and it is thus possible to prevent a failure when the piezoelectric valve 1 is used for an ejector valve or the like of the optical sorting machine and a plurality of such ejector valves are arranged in parallel.

In the piezoelectric valve 1, in response to start of current conduction to the piezoelectric elements 32 of the actuators 3 in a closed valve state, the piezoelectric elements 32 expand. In accordance with the expansion of the piezoelectric elements 32, the acting parts 34 are displaced, the valve discs 35 are spaced apart from the valve seats 42, and thereby the valve is opened. Accordingly, the piezoelectric valve 1 discharges a compressed gas, which is supplied from the gas supply port 21 to the valve body 2, out of the discharge ports 52 opened in the front face of the connector part 5 via the gas discharge ports 22, which is opened in the front face of the valve body 2 from the discharge paths 45 formed in the valve seat part 41 of the valve seat plate 4. On the other hand, in the piezoelectric valve 1, in response to stop of the current conduction to the piezoelectric elements 32 of the actuators 3, the piezoelectric elements 32 contract, the acting parts 34 are displaced in the opposite direction, the valve discs 35 are seated in the valve seats 42, and thereby the valve is closed.

The piezoelectric valve 1 in the embodiment of the present invention employs the configuration such that the valve seats 42 of the valve seat plate 4 are provided to both the faces of the valve seat part 41 as a pair opposing to each other so as to at least partially overlap each other in the width direction in front view, the discharge paths 45 having one end opened in the valve seats 42 provided to both the faces of the valve seat part 41 as the pair opposing to each other are formed in the valve seat plate 4 so as to at least partially overlap each other in the width direction, the other ends of the plurality of discharge paths 45 are opened in a non-straight manner in the width direction in the front face of the valve seat plate 4, the plurality of gas discharge ports 22 are opened in a non-straight manner in the width direction in the front face of the valve body 2 in which the valve seat plate 4 is accommodated, and discharge ports 52 of the plurality of discharge passages are opened in a line in the width direction in the front face of the connector part 5. Thus, in the piezoelectric valve 1, even when the plurality of gas discharge ports 22 are not opened in a line in the width direction in the front face of the valve body 2, the gas discharge ports can be aligned and opened in a line in the width direction in the front face of the valve.

In the piezoelectric valve 1 in the embodiment of the present invention, the plurality of discharge passages formed in the connector part 5 have spaces of substantially the same spatial volume and have openings (discharge ports 52) of substantially the same opening area in the front face of the connector part 5, and the plurality of gas discharge ports 22 opened in the front face of the valve body 2 have substantially the same opening area. Thus, in the piezoelectric valve 1, various characteristics such as a gas ejection amount and speed from the front face of the valve, responsiveness, and the like can be designed to have substantially the same among the plurality of discharge passages to maintain a good state comparable to a case where the connector part 5 is not provided.

In the embodiment described above, the piezoelectric valve 1 is configured such that the valve disc 35 is seated in the valve seat 42 in a state where the voltage is not applied to the piezoelectric element 32. However, the embodiment is not limited to such a configuration. The piezoelectric valve 1 can also be configured such that the polarity of the voltage or the like supplied from a drive unit is changed into a state where the valve disc 35 is spaced apart from the valve seat 42 in a state where no voltage is applied to the piezoelectric element 32.

In the embodiment described above, in the piezoelectric valve 1, two actuators 3 are fixed to each of both side faces of the valve seat plate 4, and four gas discharge ports 22 are opened in the front face of the valve body 2. However, the embodiment is not limited to such a configuration, and the piezoelectric valve 1 can also be configured such that, for example, two actuators 3 are fixed to only one side face of the valve seat plate 4, or one actuator is fixed to each of both side faces of the valve seat plate 4 so that two gas discharge ports 22 are opened in the front face of the valve body 2.

While the embodiment of the present invention has been described above, the present invention is not limited to the embodiment described above and can be implemented by changing the configuration thereof as appropriate without departing from the scope of the invention.

### INDUSTRIAL APPLICABILITY

The piezoelectric valve according to the present invention can be used for a piezoelectric valve including: a plurality of actuators having a plurality of valve discs and configured to drive the valve discs in parallel planes, respectively, individually; a valve seat plate having a plurality of valve seats, which are contacted with and separated from the plurality of valve discs, respectively, individually, and a plurality of discharge paths and configured to fix the plurality of actuators; and a valve body, that is, a body case configured to accommodate the valve seat plate.

### LIST OF REFERENCE NUMERAL

1 piezoelectric valve
2 valve body (body case)
21 gas supply port
22 gas discharge port
25 packing
3 actuator
31 base part
32 piezoelectric element
33 support part (displacement amplifying mechanism)
331 narrow part
34 acting part (displacement amplifying mechanism)
35 valve disc
36 compression member
381 mounting hole
382 mounting hole
4 valve seat plate
41 valve seat part
42 valve seat
43 mounting part
44 mounting part
45 discharge path
46 lid
47 electrode
48 wiring pin
49 cable
5 connector part
51 intake port
52 discharge port
521 the other end side opening
522 one end side opening
53 screw
55 packing
6 cover
7 ejector
71 manifold (fluidic device)
711 air space
712 feed passage
713 exhaust passage
72 nozzle member
721 nozzle hole
81 screw
82 screw
83 screw
84 screw
85 packing
86 O-ring

1. A piezoelectric valve comprising:
a plurality of actuators having a plurality of valve discs and configured to drive the plurality of valve discs in parallel planes, respectively, individually;
a valve seat plate having a plurality of valve seats and a plurality of discharge paths and configured to fix the plurality of actuators, the valve seats being contacted with and separated from the plurality of valve discs, respectively, individually; and
a body case configured to accommodate the valve seat plate,
wherein each of the plurality of actuators comprises:
a base part fixed to the valve seat plate,
a piezoelectric element extending in a first longitudinal direction, one end of the piezoelectric element being connected to a mounting surface of the base part,
a support part provided integrally with the base part, arranged adjacent to the piezoelectric element, and extending in a second longitudinal direction intersecting the first longitudinal direction, and
an acting part connected to the other end of the piezoelectric element and a tip of the support part and configured to be displaced in a direction which is different from both the first longitudinal direction and the second longitudinal direction in accordance with expansion and contraction of the piezoelectric element,
wherein the valve disc is provided on a side of the direction that displacement of the acting part occurs and driven by the displacement of the acting part,
wherein the valve seat plate has a valve seat part in which the valve seats and the discharge paths are formed, and the plurality of valve seats are provided to both faces on a front face side and a rear face side of the valve seat part,
wherein the plurality of actuators are fixed to side faces of the valve seat plate so that each of the valve discs faces each of the valve seats,
wherein the body case comprises:
a gas supply port supplied with a compressed gas, and
a plurality of gas discharge ports configured to, by separation of the plurality of valve discs and the plurality of valve seats from each other, discharge a compressed gas, supplied from the gas supply port, via the plurality of discharge paths of the valve seat plate, respectively, individually,
wherein the body case is configured to be attached to and detached from a fluidic device via a connector part provided to a front face of the body case,
wherein the connector part has an intake passage and a plurality of discharge passages, one end of the intake passage is configured to communicate with the gas supply port opened in the front face of the body case while the other end of the intake passage is configured to communicate with a feed passage formed in the fluidic device, and one ends of the plurality of discharge passages are configured to respectively communicate with the plurality of gas discharge ports opened in the front face of the body case, while the other ends of the plurality of discharge passages are configured to respectively communicate with a plurality of exhaust passages formed in the fluidic device,
wherein the valve seats of the valve seat plate are provided as a pair to both the faces of the valve seat part so as to overlap each other at least partially in a width direction in front view,
wherein the discharge paths having one ends opened in the valve seats provided as a pair to both the faces of the valve seat part are formed in the valve seat plate so as to overlap each other at least partially in the width direction,
wherein in a front face of the valve seat plate, the other ends of the plurality of discharge paths are opened in a non-straight manner in the width direction,
wherein in the front face of the body case, the plurality of gas discharge ports are opened in a non-straight manner in the width direction, and
wherein in a front face of the connector part, discharge ports of the plurality of discharge passages are opened in a line in the width direction.

2. The piezoelectric valve according to claim 1, wherein the plurality of discharge passages of the connector part respectively have spaces of the same volume, and have openings of the same opening area in the front face of the connector part.

3. The piezoelectric valve according to claim 2, wherein the plurality of gas discharge ports of the body case have openings of the same opening area in the front face of the body case.

4. The piezoelectric valve according to claim 1, wherein the fluidic device is a manifold, feeds a supplied compressed gas supplied from a compressed gas source, into the body case from the feed passage via the intake passage of the connector part, and exhausts a discharged compressed gas, discharged out of the body case, from the plurality of exhaust passages via the plurality of discharge passages of the connector part.
